(19) United States
(12) Patent Application Publication
(10) Pub. No.: US 2024/0084704 A1
(43) Pub. Date: Mar. 14, 2024

(54) WIND TURBINE SYSTEM

(71) Applicant: Larry Jeffus, Elkhart, KS (US)

(72) Inventor: Larry Jeffus, Elkhart, KS (US)

(21) Appl. No.: 17/943,912

(22) Filed: Sep. 13, 2022

(51) Int. Cl. F01D 5/14; F01D 5/28; F03D 9/00

(52) U.S. Cl. CPC F01D 5/141; F01D 5/28; F03D 9/007; F05B 2220/708

(57) ABSTRACT

A wind turbine system can employ any number of wind turbine blades each having a continuous leading edge extending from a hub to a blade tip. The leading edge of a turbine blade can have a first cross-sectional shape corresponding to a first lift profile. A portion of the leading edge of the turbine blade may be covered by a continuous flexible sheet of material that defines a lifting edge that provides a second lift profile for the turbine blade that differs from the first lift profile.

### SUMMARY

A wind turbine system, in accordance with some embodiments, can provide optimized utilization of available natural resources over time.

In accordance with some embodiments, a wind turbine system has wind turbine blades each having a continuous leading edge extending from a hub to a blade tip. The leading edge of a turbine blade has a first cross-sectional shape corresponding to a first lift profile. A portion of the leading edge of the turbine blade is covered by a continuous flexible sheet of material that defines a lifting edge that provides a second lift profile for the turbine blade that differs from the first lift profile.

A wind turbine, in other embodiments, has a wind turbine blade with a continuous leading edge extending from a hub to a blade tip. The leading edge has a first cross-sectional shape corresponding to a first lift profile for the wind turbine blade. A first continuous flexible sheet of material is affixed to the wind turbine blade to cover a first portion of the leading edge with the first continuous flexible sheet of material defining a first lifting edge that provides a second lift profile that differs from the first lift profile. A second continuous flexible sheet of material is affixed to the wind turbine blade to cover a second portion of the leading edge with the second continuous flexible sheet of material defining a second lifting edge that provides a third lift profile that differs from the second lift profile.

Embodiments of a wind turbine system can operate by attaching a first continuous flexible solar sheet around a leading edge of a wind turbine blade with at least one attachment feature. The leading edge continuously extends from a hub to a blade tip while the at least one attachment feature temporarily secures the first continuous flexible solar panel in place during generation of lift and movement of the wind turbine blade. Electricity is generated in response to wind rotating the wind turbine blade around the hub before damage to the first continuous flexible solar sheet is detected and the first continuous flexible solar sheet is replaced with a second continuous flexible solar sheet

### BRIEF DESCRIPTION OF THE DRAWINGS

FIG. 1 is a block representation of an example power generation environment in which assorted embodiments can be practiced.

FIG. 2 depicts a representation of portions of an example electrical power generation system capable of being used in the environment of FIG. 1.

FIGS. 3A-3C respectively depict portions of an example wind turbine system configured in accordance with various embodiments.

FIGS. 4A & 4B respectively depict cross-sectional representations of portions of an example wind turbine system arranged in accordance with some embodiments.

FIG. 5 depicts a line representation of portions of an example wind turbine system.

FIG. 6 depicts a block representation of an example wind turbine system operated in accordance with assorted embodiments.

FIG. 7 depicts portions of an example wind turbine system serviced in accordance with some embodiments.

FIG. 8 depicts an example power generation routine that can be carried out with the various embodiments of FIGS. 1-7.

FIG. 9 conveys an example turbine maintenance routine that may be employed as part of a wind turbine system in assorted embodiments.

### DETAILED DESCRIPTION

Various embodiments of the current disclosure are generally directed to a system that increases the capabilities and usable lifespan of a wind turbine.

As electrical generation has evolved with technology, wind turbines have become capable of harnessing increasing volumes of moving air to generate greater amounts of electricity. By enlarging the size of wind turbine blades, larger volumes of air can produce greater blade velocities, torque, and electricity. However, bigger, and perhaps more complex, wind turbine blades can be increasingly susceptible to degradation over time. With the maintenance of wind turbine performance and efficiency over time tending to be laborious, expensive, and dangerous, there is an industry goal of reducing the inefficiencies and difficulties of wind turbine blade maintenance while prolonging turbine blade lifespans.

Accordingly, embodiments are generally directed to incorporating a cover for at least the leading edge of a wind turbine blade to protect the integrity of the lift generating portions of a wind turbine over time. The ability to efficiently change a turbine blade cover allows for dynamic leading edge shapes and configurations that can customize the generation of lift and optimize the generation of electricity. Some embodiments involve utilizing a flexible solar panel to cover portions of a wind turbine blade leading edge, which enables the concurrent harnessing of natural resources while protecting a wind turbine blade from damage. The use of multiple different electrical generation means on a wind turbine blade can optimize the spinning reserve of a wind turbine and the profitability of generating power.

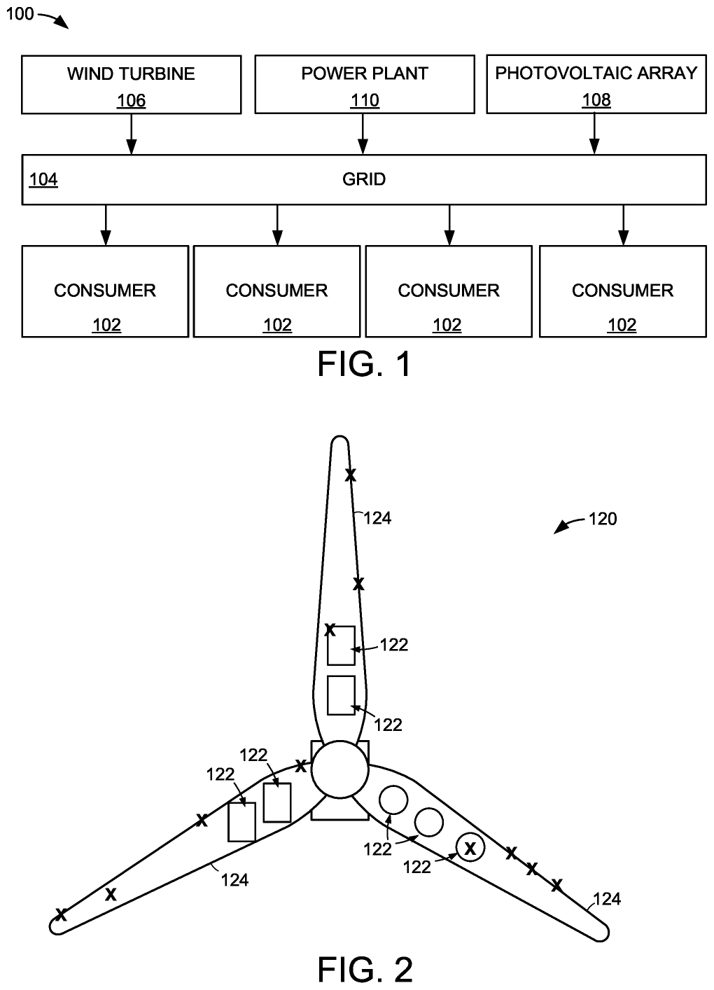

An example power generation environment 100 is conveyed in FIG. 1 as a block representation that provides electricity to one or more consumers 102 via an electrical grid 104. Although not required or limiting, a power generation environment 100 can employ any number and type of electricity generation that is concurrently, or sequentially, supplied for use to the connected consumers 102. Moving air (wind) can be employed to generate electricity in a wind turbine 106 just as ultraviolet rays of the sun can be transitioned into electricity by a photovoltaic array 108, which can be characterized as a solar circuit. It is contemplated that other natural resources can be harnessed to supply the grid 104 with electricity, such as hydroelectric, tidal, and geothermal resources.

The grid 104, in some embodiments, is supplied with power from one or more power plants 110 that consume fuel to generate electricity. A power plant 110 may be any size, type, and location to provide electricity upon demand. For instance, a power plant 110 may consume natural gas, hydrogen, coal, petroleum, or wood to produce electricity with one or more generators. It is noted that a power plant 110 may utilize radiation to create steam as part of a nuclear electricity generation. Regardless of the type and number of power plants 110, the grid 104 can be supplied with electricity from a number of different sources, or a single source, to satisfy the electrical needs of one or more consumers 102.

However, each power generation means of FIG. 1 has practical advantages and disadvantages that commonly result in a combination of electricity sources being connected to a grid 104. For a power plant 110, high output and reliable production are counterbalanced by dynamic pricing and environmental pollution. In the case of nuclear power generation, the disposal of spent rods can be particularly hazardous. Meanwhile, gas/oil pricing can be particularly volatile in certain times of the year for other power plants 110.

Employing one or more wind turbines 106 can harness moving air to rotate a generator and create electricity without destroying any fuel, such as gas, oil, or coal. However, wind turbines 106 can suffer from a limited range of wind speeds that are conducive to generating electricity. As such, little, or no, electricity is produced by wind turbines 106 when wind speeds are very low or very high, depending on the size and configuration of the wind turbine 106. While wind turbines 106 can operate at any time during day or night to produce electricity, routine maintenance to the moving aspects of a turbine 106 can be tedious, lengthy, and dangerous. The volatility of weather and animals can compound routine operational degradation of a wind turbine 106 to inhibit the turbine's electricity harnessing capability. For instance, bird strikes and/or hail events can alter the ability of a turbine blade to produce lift and efficiently rotate at a given wind speed, which jeopardizes the performance and reliability of the wind turbine 106.

The utilization of one or more photovoltaic arrays 108 can capture the sun's energy and produce electricity. It is noted that photovoltaic arrays 108 can come in a variety of configurations, such as flat panels, flexible sheets, and three-dimensional shapes. Regardless of the physical configuration of an array 108, the electricity producing capability is inherently limited by the presence of UV rays from the sun, which negates night-time energy production. Further, the presence of dirt and/or debris on the surface of a photovoltaic array 108 can diminish the efficiency of the conversion of the sun's energy into electricity by the array 108.

Despite the operational challenges and decreased efficiency of a wind turbine 106 and photovoltaic array 108 over time, consumers 102 can enjoy ample supply of electricity with the supplementation of one or more fuel-consuming power plants 110. Hence, assorted embodiments are directed to increase the operational efficiency of a wind turbine 106 and photovoltaic array 108 by combining the two electricity generating aspects.

FIG. 2 depicts portions of an example power generation system 120 arranged in accordance with various embodiments to physically combine a solar panel 122 with a blade 124 of a wind turbine 106. It is contemplated that one or more flat solar panels 122 can be physically attached to any portion of a wind turbine 106 to convert UV rays into electricity used immediately or stored in batteries to be used at a later time.

However, the combined use of solar panels 122 and a wind turbine 106 does not solve the assorted operational issues encountered over time. For instance, weather, and/or birds can inflict physical damage on the respective solar panels 122 and turbine blades 124, as illustrated by solid X in FIG. 2. Such physical damage can alter the operation and electricity producing capabilities of either the solar panel 122 or wind turbine 106. As a non-limiting example, physical damage can change how light is absorbed by a solar panel 122, the transmission of electricity within the solar panel 122, the generation of lift by a turbine blade 124, and ability to turn a generator at a certain wind speed.

It is noted that the concurrent production of electricity during daylight hours from solar panels 122 and rotating turbine blades 124 can provide greater power volume than either electricity generating aspect alone. Yet, the combination of solar and wind harvesting equipment can be impractical over time due to the threats of physical damage and/or degradation of electricity producing aspects during routine operation. For example, placing a solar panel 122 on a turbine blade 124 can place physical stress on the blade 124 that alters how lift is produced and harnessed to rotate a local generator.

As another example, movement of a solar panel 122 and attachment to a turbine blade 124 oriented to harness moving air can result in less than optimal volumes of UV rays reaching the photovoltaic cells of the solar panel 122. Thus, simple inclusion of solar panels 122 on a wind turbine 106 does not provide optimal electricity production and, arguably, inhibits optimal profitability and performance of a wind turbine 106 due to the increased initial cost of materials and greater volume of maintenance, and/or repair, to retain electricity production over time. Accordingly, embodiments of a wind turbine system integrate photovoltaic cells, and solar harnessing capabilities, with greater sustained operational performance and mitigated maintenance burden over time.

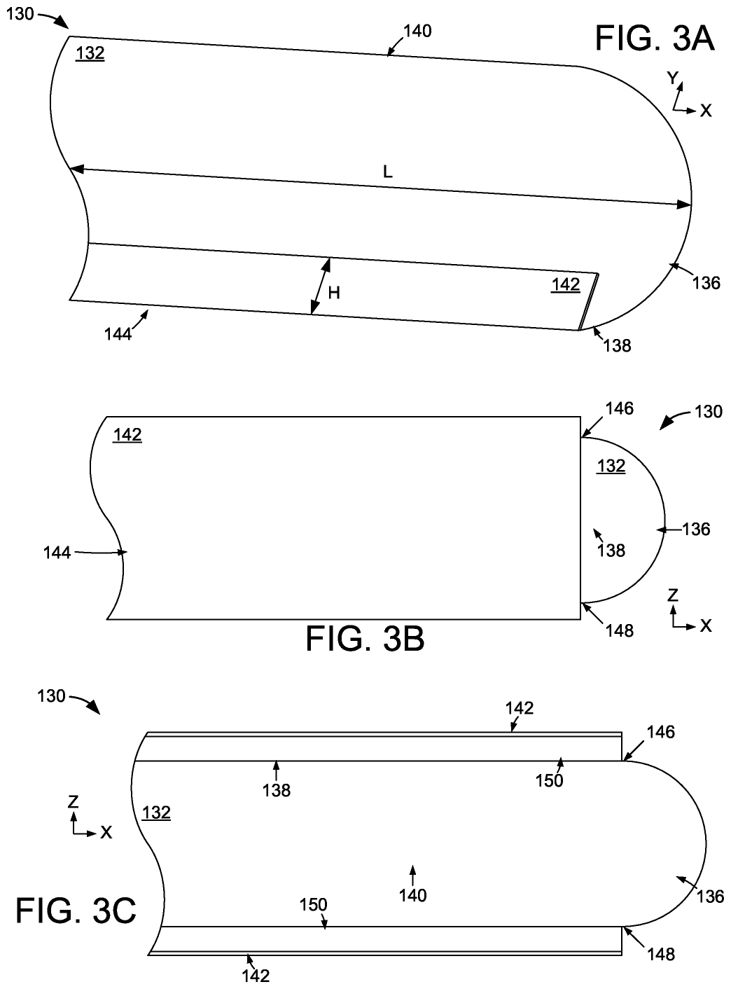

FIGS. 3A-3C respectively depict portions of an example wind turbine system 130 that is configured in accordance with some embodiments to provide optimized harnessing of natural resources. The front view line representation of FIG. 3A illustrates how a wind turbine blade 132 has a length (L) that extends from a hub to a tip 136 along the X axis and a height (H) that extends from a leading edge 138 to a trailing edge 140 along the Y axis. It is noted that the blade 132 may be contoured in the X-Y plane to have varying topography, such as a tilt, protrusion, or recess.

As shown, a solar sheet 142 is affixed to the blade 132 and covers portions of the leading edge 138. The solar sheet 142 can be configured with any shape, size, and orientation relative to the underlying blade 132, but various embodiments continuously extend one or more solar sheets 142 to form a lifting edge 144 that replaces the lift provided by the underlying leading edge 138. By utilizing flexible solar sheets 142 instead of flat, rigid solar panels, the lifting edge 144 can be formed and secured without jeopardizing the lifting aspects of the blade 132. In fact, the use of a flexible sheet 142 can customize the lifting characteristics of the blade 132 and provide greater electricity producing capabilities compared to the original leading edge 138.

The bottom view of the turbine blade 132 in FIG. 3B conveys how one or more solar sheets 142 continuously wrap around the leading edge 138 of the blade 132 so that the lifting edge 144 is not impeded or discontinued from a top surface 146 to a bottom surface 148 of the blade 132. The configuration of the solar sheet(s) 142 act to protect the underlying portions of the turbine blade 132 without changing the operational performance of the blade 132, unless desired by arranging the lifting edge 144 to be different than the underlying leading edge 138. It is contemplated that the solar sheet(s) 142 are configured with texture, such as dimples, ridges, protrusions, and/or recesses, that provide different aerodynamic characteristics than the underlying leading edge 138. The ability to customize the leading edge 138 of the blade 132 with material that concurrently protects the blade 132 while providing electricity production allows a wind turbine to provide optimal performance over time.

In the top view of FIG. 3C, the attachment of the solar sheet(s) 142 is visible and produces a gap 150 between the surface of the blade 132 and the sheet(s) 142. While the gap 150 is not required and the sheet(s) 142 can be adhered directly onto the surface of the blade 132, the presence of the gap 150 allows for the lifting edge 144 to have a different configuration than the underlying leading edge 138, which can provide different lift and aerodynamic characteristics than the configuration of the blade 132 itself. Through designed configuration of the gap 150, operational efficiency of the system 140 can be improved. For instance, the gap 150 can allow for slight movement in the solar sheet 142, air to flow between the leading edge 138 and the solar sheet 142, and/or cushioning material to be placed to absorb and mitigate stress on a solar sheet 142.

It is contemplated that the some, or all, of the solar sheet(s) 142 are arranged without electricity producing photovoltaic cells. Such a non-electricity producing configuration transitions aspects of the sheet(s) 142 into physical barriers that protect the underlying portions of the turbine blade 132. Employing non-electricity producing sheets 142 are not limiting, or required, but can allow for efficient mitigation of physical damage to a leading edge 138 without repairing the physical damage. That is, instead of repairing physical damage to a blade 132, one or more solar sheets 142 that may, or may not, have photovoltaic cells can be placed over a damaged area to provide desired lift and aerodynamic characteristics for the blade 132 despite underlying damage.

Some embodiments of the solar sheet 142 provide different configurations for the gap proximal to the top surface 146 compared to the bottom surface 148. For example, the gap 150 may be small, or non-existent, at the top surface 146 while being greater proximal the bottom surface 148. The ability to customize the length, shape, and gap of the solar sheet 142 allows for a diverse variety of configurations that can be constructed to improve, or simply change, the aerodynamic characteristics of portions of the turbine blade 132. It is noted that the example embodiment shown in FIGS. 3A-3C does not provide solar sheet 142 coverage of the blade tip 136 or a large portion of the top 146 or bottom 148 surfaces of the blade 132. Such configuration is not required and assorted embodiments utilize continuous, or separated, solar sheets 142 on portions of the blade 132 left uncovered in the embodiment of FIGS. 3A-3C. Hence, the use of solar sheets 142 affixed to a turbine blade 132 is unlimited and can be arranged to provide customized combinations of solar and wind harvesting while providing selected aerodynamic characteristics and mitigating the burden of maintenance.

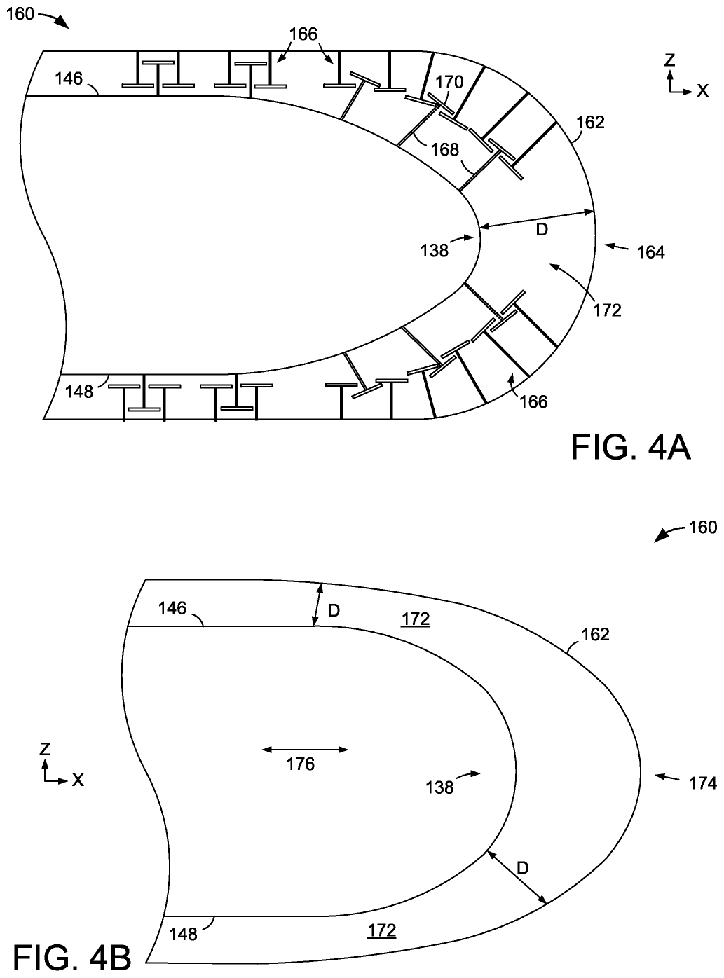

FIGS. 4A & 4B respectively depict cross-sectional line representations of lifting sections for example wind turbine blades that are customized for protection and aerodynamic characteristics. The example blade 160 of FIG. 4A illustrates how a single continuous sheet 162 of material extends from a top surface 146 to a bottom surface 148 with a shape defining a lifting edge 164 that controls how air moves across the leading portion of the blade 160.

While the continuous sheet 162 can be affixed directly onto the surface of the leading edge 138 to provide a matching cross-sectional shape, various embodiments configure the continuous sheet 162 with a different cross-sectional shape than the underlying leading edge 138 to customize at least the production of lift to force the blade 160 to rotate around a central wind turbine hub. The example cross-sectional shape of the lifting edge 164 can be supported by one or more attachment features 166 that operate to physically secure the continuous sheet 162 to the surfaces 146/148 of the blade 160 and maintain the cross-sectional shape of the sheet 162 as the blade 160 operates. That is, the attachment features 166 can connect the sheet 162 to the blade 160 and physically support a single cross-sectional shape during the production of lift or passage of air across the lifting edge 164.

The structure, number, type, and size of attachment features 166 is not limited to a particular configuration and may involve multiple features 166 with different structural and/or functional configurations being used concurrently. The example attachment feature 166 of FIG. 4A has rigid posts 168 affixed to, and respectively extending from, the surface of the blade 160 and the continuous sheet 162 to physically engage one another with a post head 170. The material, size, and shape of the respective features 166 can be selected to provide a minimum amount of physical retention while allowing the continuous sheet 162 to be removed without altering the surface of the blade 160 or affixed attachment features 166. That is, the post-type attachment features 166 allow for secure connection while in use and selective disconnection during maintenance to separate the sheet 162 from the surface of the blade 160, which allows for alteration of the cross-sectional shape, replacement of the sheet 162, and/or maintenance of the leading edge 138 of the blade 160.

Other embodiments of an attachment features 166 consist of adhesive, grooves, protrusions, fasteners, magnets, and/or springs to support a consistent cross-sectional shape of the sheet 162 during use while allowing for efficient removal and replacement during maintenance operations. In other words, the attachment features 166 can be selected, positioned, and configured to physically secure the sheet 162 to the blade 160 until a maintenance operation subsequently removes and replaces the sheet 162 without changing the attachment features 166. As such, the attachment features 166 allow for interchangeability of a sheet 162 without altering the structure of the blade 160, leading edge 138, sheet 162, or attachment features 166.

The selection and configuration of the attachment features 166 can additionally allow for control of the size and shape of the gap 172 between the surface of the blade 160 and the bottom of the continuous sheet 162. By separating the continuous sheet 162 from the leading edge 138 of the blade 160 with a continuous gap 172, varying cross-sectional shapes can be constructed and supported by the attachment features 166 that occupy portions of the gap 172. In contrast to attaching the sheet 162 directly to the surface of the blade 160, such as with adhesive and/or fasteners, the use attachment features 166 provide interchangeability of the sheet 162 and customization of the cross-sectional shape of the lifting edge 164, as defined by the variable distances (D) between the leading edge 138 and continuous sheet 162.

It is contemplated that the continuous sheet 162 physically contacts opposite surfaces 146/148 of the blade 160, which corresponds with a zero gap distance (D). Such contact can provide laminar airflow and reduce the occurrence of turbulence. However, other embodiments deliberately separate the edges of the continuous sheet 162 from the surface of the blade 160 to allow air to enter the gap 172, which can provide aerodynamic characteristics that provide optimized operation in some conditions, such as wind speed, direction, or blade velocity. Hence, the use of attachment features 166 allows for customized gap 172 configurations that can optimize how air flows across the lifting edge 164.

The cross-sectional shape of the alternate lifting edge 174 of FIG. 4B illustrates how a continuous sheet 162 can be arranged with a symmetric configuration about an edge axis 176, parallel to the X axis, while being different than the cross-sectional profile of the blade's leading edge 138 that is also symmetric about the edge axis 176. Thus, a designer can select to arrange any number of different cross-sectional sheet 162 profiles that are symmetric about the edge axis 176, as shown in FIG. 4B, or asymmetric about an edge axis, as shown in FIG. 4A. The ability to remove and replace the continuous sheet 162 without altering or damaging the underlying surface of the blade 162 allows for different customizations of lift characteristics over time for a single wind turbine blade 160.

Just as the cross-sectional shape of the continuous sheet 162 can be customized, the gap 172 can be configured in a diverse variety of shapes and sizes to physically support and position the lifting edge 164 to provide desired aerodynamic characteristics and lift producing capabilities. Some embodiments of the lifting edge 164 partially, or completely, fill the gap 172 with one or more dampening materials, such as foam, fabric, rubber, or plastic, that aids in physically maintain the integrity and position of the continuous sheet 162 with a particular cross-sectional shape. The use of such dampening materials can mitigate damage to a sheet 162 from various trauma, such as hail and birds.

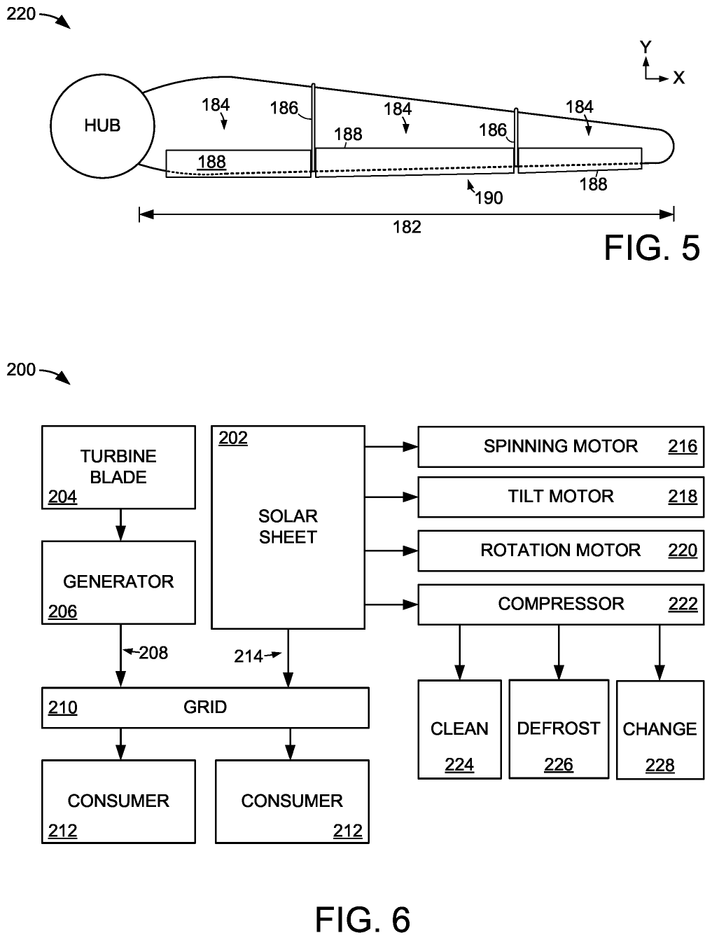

The ability to customize assorted aspects of a lifting edge 164 can result in more than one configuration for a single turbine blade 160. That is, a continuous lifting edge 164 along a length of a turbine blade 160 can be configured with multiple different cross-sectional shapes, sizes, and positions relative to the underlying leading edge 138 of the blade 160. FIG. 5 depicts portions of an example wind turbine blade 180 that can be utilized in a wind turbine system in accordance with various embodiments. The example blade 180 has an overall length 182 that is deliberately segmented into multiple sections 184 that respectively have different aerodynamic characteristics.

While not required or limiting, the assorted sections 184 can be defined by physical barriers 186 that extend from the surface of the blade 180 to provide lateral support for one single sheet 188 of material or several adjacent sheets 188 of material, which may or may not contain photovoltaic cells that convert UV rays to electricity. The respective barriers 186 may have matching, or dissimilar structure, such as material construction, height, width, and shape, to control how air flows across the blade 180 while providing physical support for the sheets 188 to prevent centrifugal force from moving the sheets 188. For instance, the barriers 186 can be permanent aspects of the blade 180 that extend between separate sheets 188 that are removable and replaceable, which provides an ability to mitigate lateral force from displacing, or otherwise changing, the shape or position of the lifting edge 190.

As shown, each physical barrier 186 continuously extends across the extent of the blade 180 and serves as a stall fence. Such arrangement disrupts spanwise flow, along the X axis, to shield portions of the blade 180 from establishing a stall condition where a sudden reduction in lift experienced. It is contemplated that the respective barriers 186 extend to less than the entirety of the width of the blade 180, along the Y axis, to customize how air flows over the blade 180 and how lift is generated. Some embodiments place any number of barriers 186 on the surface of the blade 180 with similar, or dissimilar, cross-sectional shapes, as viewed along the Y axis, that collectively manipulate the amount of lift that is generated for an angle of attack for the blade 180. It is noted that a barrier 186 can continuously extend beyond the surface and extent of the blade 180, which can further allow customization of how airflow generates lift.

The configuration of the barriers 186 can aid the physical support of the lifting edge 190 with attachment features occupying portions of a gap between the sheets 188 and surface of the blade 180. It is contemplated that a barrier 186 can configured to produce lift, direct air, and/or reduce turbulence. The barriers 186, in some embodiments, can serve to segment airflow, and the generation of lift, to differently configured lifting edge 190 sections. That is, various portions of a continuous lifting edge 190, as defined by one or more continuous sheets 188, can have different cross-sectional profiles, sizes, and/or positions relative to an underlying leading edge to provide a dynamic lift generation along the length 182 of the blade 180. As a result of such dynamic lift across the blade's length 182, the operational range, performance, and/or efficiency of the blade 180, as part of a wind turbine, can be manipulated and optimized, such as decreasing a minimum speed to generate electricity or increase rotational blade speed for a given wind velocity.

With the customized position and structure of the respective barriers 186, the integrity of the lifting edge 190 can be maintained over time. The barriers 186 can additionally support the presentation of different lifting edge 190 profiles. For instance, the barriers 186 can serve to mitigate flexing, movement, and vibration that can occur with generation of dynamic amounts of lift along the blade's length 182. Accordingly, the combination of rigid barriers 186 with a continuous lifting edge 190 that is customized to provide predetermined aerodynamic characteristics that correspond with optimized electricity generation and blade maintenance over time.

FIG. 6 depicts a block representation of portions of an example wind turbine system 200 that utilizes one or more flexible solar sheets 202 to define a lifting edge that covers at least a portion of a leading edge of a turbine blade 204. As a product of motion of the turbine blade 204, portions of a generator 206 rotate to produce electricity 208 that is sent to a grid 210 that services various consumers 212. Meanwhile, one or more solar sheets 202 can convert solar energy into electricity 214 that is provided to the grid 210. In this way, dual electricity 208/214 sources can be concurrently and/or sequentially employed to service consumers 212.

In some embodiments, electricity 214 produced by a solar sheet 202 can be consumed locally at the turbine. It is contemplated that generated electricity 214 is stored locally in batteries for later use and/or immediately consumed to provide a service. While not required or limiting, solar energy can be utilized to maintain turbine blades 204 rotating about a central hub, which can increase the ability of the turbine to produce electricity 208. For instance, one or more motors 216 can supplement wind speed to increase the production of electricity 208 or reduce the minimum wind speed necessary to produce electricity 208 for the grid 210.

Solar sheets 202 can also be employed to tilt one or more blades 204 about a radial axis of the turbine's hub. That is, a tilt motor 218 can utilize electricity 214 to articulate a blade 204 to alter the aerodynamics and operating behavior of the blade 204. A rotation motor 220 may similarly utilize electricity 214 to rotate a nacelle of a turbine, which consequently rotates the hub and connected blades 204 in a desired orientation relative to a ground surface. The ability to power locally resident motors with solar source electricity 214 can provide optimized turbine operation without having to siphon or interrupt wind powered electricity 208 generation.

While local motor consumption of electricity 214 can increase efficiency of electricity 208 generation, various embodiments employ solar electricity 214 to operate a fluid compressor 222 to create a cache of non-electrical energy. As an example, air can be compressed into a local storage tank to be used at a later time to clean 224, defrost 226, and/or change blade 204 operation. For instance, compressed air can be expelled from static, or dynamic, nozzles to remove dust, dirt, and debris from the surface of a solar sheet 202. The local generation and storage of compressed air allows solar sheets 202 to be cleaned at any time, such as during rotation on a turbine blade 204 or immediately in response to detected presence of contaminants on a sheet's surface.

One or more nozzles can expel pressurized fluid, such as air or liquid, alternatively to remove ice from a solar sheet 202 and/or portions of a turbine blade 204. The forceful removal of ice with pressurized fluid may, in some embodiments, coincide with one or more heating elements that utilize electricity 208/214 to melt ice. The removal of ice can serve to increase a turbine's ability to produce electricity 208 despite below freezing temperatures as well as prevent damage to a turbine due to the weight of ice.

With storage of fluid under pressure, a variety of performance optimizations can be provided for a turbine blade. For instance, compressed air can be released from portions of a blade 204 to speed up, or slow down, the rotational velocity of the blade 204. Such manipulation of the velocity of a blade 204 can increase the operational range of wind speed that can produce electricity 208, which consequently raises the capability of a turbine to produce a volume that satisfies demand of a grid 210.

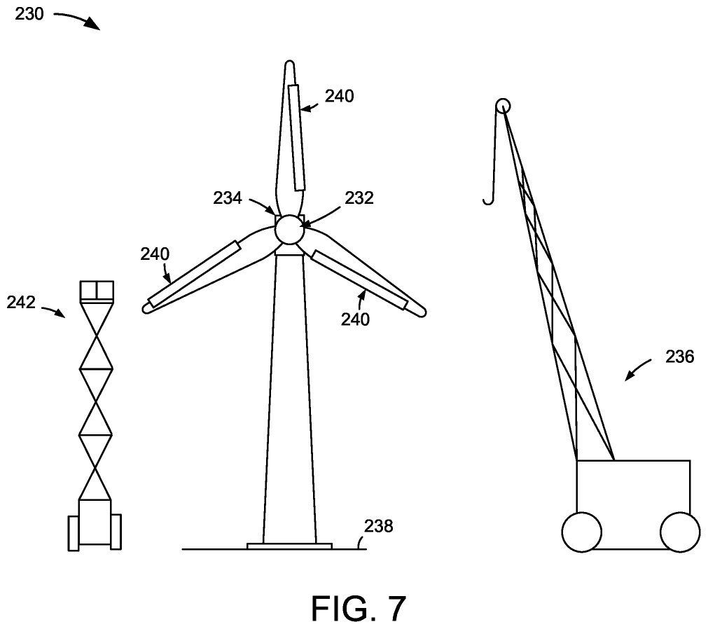

The use of electricity 214 to conduct assorted tasks for a turbine can optimize operation and provide increased performance capabilities. However, solar sheets 202 can additionally reduce the burden of maintenance for a turbine over time. FIG. 7 illustrates portions of an example wind turbine system 230 under different maintenance operations. Conventionally, a turbine hub 232 is removed from a nacelle 234 by a crane 236 and brought to a ground surface 238 to perform inspection, repair, and/or replacement of various aspects of the rotating assembly as well as the nacelle 234. By using a crane 236, a turbine experiences considerable downtime as multiple workers conduct dangerous and precise operations that remove, fix, and return portions of the turbine to rotating tolerances that safely produce electricity.

Through the attachment of flexible solar sheets 240 onto at least the leading edge of turbine blades, damage over time is reduced as impact is absorbed by the sheets 240. The reduction of damage to the primary lift producing portions of the turbine blades allows a ground supported lift 242 to service the respective blades without removal from the nacelle 234 or hub. That is, the presence of the solar sheets 240 preserves the operational longevity of the turbine blades by reducing damage to the actual blade surface. The ability to access and/or replace solar sheets 240 with a lift 242, such as a scissor lift or bucket truck, from the ground allows the turbine to remain in service for longer periods of time compared to employing conventional, naked turbine blades.

It is noted that the rotating portions of a turbine will still require a crane 236 for maintenance over time, but the use of solar sheets 240 will reduce the frequency of crane 236 use in response to blade damage. Various embodiments of the turbine system 230 also utilize the ground mounted lift 242 to conduct proactive service without removing a blade from a nacelle 234, such as changing a cross-sectional profile of a flexible solar sheet 240 to alter the aerodynamics and/or lift production of a blade. Accordingly, employing solar sheets 240 reduces the maintenance burden associated with wind turbine operation while separately producing electricity and allowing for proactive customization of the aerodynamics of a turbine blade.

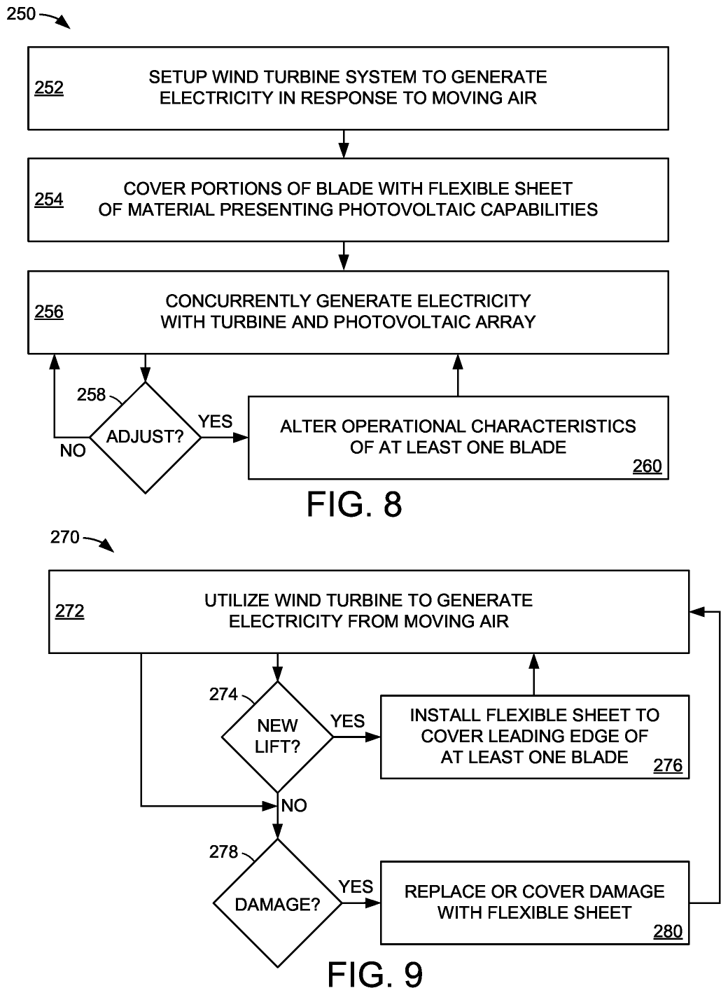

FIG. 8 depicts an example power generation routine 250 that can be conducted with a wind turbine system in accordance with various embodiments. A wind turbine system initially is setup in step 252 to generate electricity in response to moving air (wind). While step 252 can be conducted alone for any amount of time, or no time at all, with moving air forcibly rotating at least one blade around a hub attached to an electrical generator. However, at least the leading edge of one or more turbine blades can be covered in step 254 with at least one flexible sheet of material that contains photovoltaic capabilities that convert UV rays into electricity.

It is contemplated, but not required, that the flexible sheet installed in step 254 defines a different cross-sectional shape/size that alters the aerodynamic characteristics and at least the generation of lift for a portion of a turbine blade. The installation and configuration of a new lifting edge portion of a turbine blade in step 254 may involve affixing one or more attachment features to the flexible sheet, surface of the blade, or both. A gap may be created, and potentially filled, between a leading edge of the blade and a bottom surface of the flexible sheet, in some embodiments. The configuration of the flexible sheet and customization of at least the blade's creation of lift in response to moving air provides the ability to concurrently generate electricity via moving air and UV from the sun in step 256.

At some point after concurrently utilizing different power sources in step 256, decision 258 evaluates if an adjustment to an existing turbine blade can optimize the aerodynamic operating parameters of a turbine blade. Decision 258 may be conducted continuously, sporadically, or in response to detected events, such as weather or animal striking a blade. In the event a change, or repair, is called for in decision 258, step 260 alters the operational characteristics of at least one blade by providing a different leading/lifting edge configuration. The adjustment of step 260 is not limited to a particular operation, but can involve adding a flexible sheet of material, removing a sheet of material, reconfiguring portions of an existing flexible sheet to provide a different cross-sectional shape/size, or alter a gap size/shape underneath a flexible sheet of material.

After an adjustment to at least one turbine blade in step 260, or if no adjustment is necessary in decision 258, step 256 is revisited to generate power and supply at least one electrical grid with electricity that can satisfy downstream consumers. Over time, the execution of routine 250 allow for customization of aerodynamic characteristics of a turbine blade that can adapt to changing conditions, such as degradation of the physical aspects of a blade, damage from impact, or dynamic weather patterns, like peak wind speed, direction, temperature, humidity, and average wind speed. The adaptation of blade characteristics with routine 250 can provide the dual benefits of optimizing lift for a blade while protecting the blade from impact damage.

FIG. 9 conveys an example turbine maintenance routine 270 that may be employed as part of a wind turbine system in assorted embodiments. A wind turbine is installed and utilized in step 272 to generate electricity from moving air. Decision 274 evaluates if a different lift profile would optimize the translation of moving air into electricity. For instance, decision 274 can determine if the existing leading edge cross-sectional shape is sub-optimal to generate the maximum volume of electricity for future wind direction, average speed, and/or peak speed. The evaluation in decision 274 can evaluate predicted weather and/or bird migratory patterns to determine if a new leading/lifting edge configuration can protect the operational performance of a turbine blade over time.

If so, step 276 installs one or more flexible sheets atop a leading edge of a turbine blade to create a lifting edge, which may extend to cover some, or all, of the leading edge of the blade. The flexible sheet is arranged in step 276 to provide a predetermined cross-sectional shape and gap configuration that is removably connected to the turbine blade via attachment features that support the sheet. It is contemplated that step 276 is conducted to provide multiple different lifting edge configurations that concurrently provide different operational lift characteristics along the blade's length.

At the conclusion of step 276, or in the event decision 274 determines no new lift characteristics are necessary to provide optimal production of electricity, decision 278 evaluates if turbine blade damage has occurred, or is eminent. The evaluation of step 278 may involve the comparison of blade behavior in response to known wind speed and direction, which can identify physical damage that degrades rotational performance of a blade. With an existing flexible sheet protecting a blade's leading edge, step 280 replaces a flexible sheet to provide a predetermined cross-sectional shape and aerodynamic characteristics, such as lift and drag. If no existing flexible sheet is present and damage is to the surface of the turbine blade itself, step 276 is conducted to install one or more flexible sheets to create a lifting edge that has a predetermined cross-sectional shape/size and corresponding aerodynamic characteristics.

It is contemplated that step 272 is revisited for any amount of time after decision 274 and/or step 276 before decision 278 evaluates the presence of damage. It is noted that a flexible sheet of material may be any material and may, or may not, have photovoltaic capabilities. Some embodiments configure a flexible sheet with both protective, non-electricity producing, portions in regions likely to be impacted by weather and/or birds, along with electricity producing photovoltaic cells that convert UV rays to electricity.

Through the various embodiments of a wind turbine system, a turbine blade can experience customized operation with decreased risk of damage and lengthy maintenance. The ability to create a lifting edge that differs from an underlying leading edge of a blade allows for a blade's lifting profile to be optimized for dynamic conditions over time. The use of multiple different lifting edge cross-sectional configurations can further optimize the response of a blade to moving air. It is noted that the non-permanent attachment of one or more flexible sheets that define a lifting edge allows for efficient maintenance with ground-based inspection, repair, and replacement without removing the blade from the hub or electrical generator. Over time, the evolution of a lifting edge in response to changing conditions and/or impact damage allows a turbine blade to remain in service for greater periods of time while providing dual electrical generation and optimized rotation about a nacelle hub.

What is claimed is:

1. An apparatus comprising a wind turbine blade having a continuous leading edge extending from a hub to a blade tip, the leading edge having a first cross-sectional shape corresponding to a first lift profile for the wind turbine blade, a portion of the leading edge covered by a continuous flexible sheet of material defining a lifting edge that provides a second lift profile that differs from the first lift profile.

2. The apparatus of claim 1, wherein the lifting edge has a continuous second cross-sectional shape that differs from the first cross-sectional shape.

3. The apparatus of claim 1, wherein the first cross-sectional shape continuously extends from the hub to the blade tip.

4. The apparatus of claim 1, wherein the second cross-sectional shape continuously extends from the hub to the blade tip.

5. The apparatus of claim 1, wherein the second cross-sectional shape continuously extends to less than an entire length of the leading edge of the wind turbine blade.

6. The apparatus of claim 1, wherein the continuous flexible sheet of material is separated from the leading edge by a gap.

7. The apparatus of claim 6, wherein the gap is partially filled with a plurality of attachment features temporarily affixing the continuous sheet of material to the wind turbine blade.

8. The apparatus of claim 6, wherein the gap is filled with a dampening material continuously extending to contact the continuous flexible sheet of material and the leading edge.

9. The apparatus of claim 1, wherein the continuous flexible sheet of material consists of a photovoltaic array.

10. The apparatus of claim 9, wherein the photovoltaic array continuously extends around the leading edge from a top surface of the wind turbine blade to a bottom surface of the wind turbine blade.

11. A wind turbine comprising:
a wind turbine blade having a continuous leading edge extending from a hub to a blade tip, the leading edge having a first cross-sectional shape corresponding to a first lift profile for the wind turbine blade;
a first continuous flexible sheet of material affixed to the wind turbine blade to cover a first portion of the leading edge, the first continuous flexible sheet of material defining a first lifting edge that provides a second lift profile that differs from the first lift profile; and
a second continuous flexible sheet of material affixed to the wind turbine blade to cover a second portion of the leading edge, the second continuous flexible sheet of material defining a second lifting edge that provides a third lift profile that differs from the second lift profile.

12. The wind turbine of claim 11, wherein the first continuous flexible sheet of material and the second continuous flexible sheet of material each contact a support barrier protruding from the wind turbine blade.

13. The wind turbine of claim 11, wherein the continuous flexible sheets are separated to expose a portion of the leading edge of the wind turbine blade.

14. The wind turbine of claim 11, wherein each lift profile is present and exposed to moving air.

15. A method comprising:
attaching a first continuous flexible solar sheet around a leading edge of a wind turbine blade with at least one attachment feature, the leading edge continuously extending from a hub to a blade tip, the at least one attachment feature temporarily securing the first continuous flexible solar panel in place during generation of lift and movement of the wind turbine blade;
generating electricity in response to wind rotating the wind turbine blade around the hub;
detecting damage to the first continuous flexible solar sheet; and
replacing the first continuous flexible solar sheet with a second continuous flexible solar sheet.

16. The method of claim 15, wherein the second continuous flexible solar sheet generates electricity from a photovoltaic array while the wind turbine blade rotates to generate electricity with a connected generator.

17. The method of claim 15, wherein the first continuous solar sheet is replaced while the wind turbine blade is connected to the hub and the hub is connected to a generator positioned in a nacelle of a wind turbine.

18. The method of claim 17, wherein the first continuous solar sheet is replaced with a lift.

19. The method of claim 15, wherein a third continuous solar sheet is positioned over damage detected on the leading edge, the third continuous solar sheet removeably attached to the wind turbine blade, separated from the leading edge by a gap, and defining a cross-sectional shape that matches the leading edge.

20. The method of claim 15, wherein the second continuous solar sheet generates lift with different cross-sectional shape than the first continuous solar sheet.
